(19) United States
(12) Patent Application Publication
(10) Pub. No.: US 2017/0333895 A1
(43) Pub. Date: Nov. 23, 2017

(54) MATRIX-ASSISTED SPECTROPHOTOMETRY

(71) Applicant: PRESIDENT AND FELLOWS OF HARVARD COLLEGE, Cambridge, MA (US)

(72) Inventors: James J. Collins, Newton, MA (US); Keith Pardee, Cambridge, MA (US)

(73) Assignee: PRESIDENT AND FELLOWS OF HARVARD COLLEGE, Cambridge, MA (US)

(21) Appl. No.: 15/519,981

(22) PCT Filed: Oct. 22, 2015
(86) PCT No.: PCT/US15/56858

§ 371 Date: Apr. 18, 2017

Related U.S. Application Data
(60) Provisional application No. 62/066,972, filed on Oct. 22, 2014.

(51) Int. Cl. B01L 3/00; G01N 21/64; G01N 21/27; G01N 21/03; G01N 21/25

(52) U.S. Cl. CPC B01L 3/5085; G01N 21/03; G01N 21/253; G01N 21/272; G01N 21/6452; B01L 2300/0829; B01L 2300/0851; B01L 2300/161; B01L 2300/069; B01L 2300/168

(57) ABSTRACT

Disclosed herein are multiwell plates suitable for spectrophotometry for low-volume liquid samples. For the multiwell plates, the bottom of at least one well has a layer of porous matrix disposed thereon, or is comprised of a layer of porous matrix. The layer of porous matrix permits a low-volume liquid sample to distribute evenly across the porous matrix. Also disclosed herein are methods of performing a photometric or spectrophotometric measurement on a liquid sample having a small volume, by using a multiwell plate comprising a layer of porous matrix.

### CROSS-REFERENCE TO RELATED APPLICATIONS

This application claims benefit under 35 U.S.C. §119(e) of the U.S. Provisional Application No. 62/066,972 filed Oct. 22, 2014, the contents of which are incorporated herein by reference in their entirety.

### TECHNICAL FIELD

The present invention relates to spectrophotometry and detection of analytes.

### BACKGROUND

Spectrophotometry is a common lab and clinical tool used to measure the output of quantitative assays, diagnostics, biochemical and molecular reactions, and DNA/RNA concentrations among others. Spectrophotometry involves irradiating a sample with light to measure optical properties such as absorbance, luminescence, or fluorescence. Spectrophotometry done using a cuvette routinely requires large sample volumes, e.g., on the order of 1000 μL. Plate-based spectrophotometry, most commonly done in 96 or 384 well plates, typically requires sample volumes of around 100 μL and 10 μL, respectively. However, once the sample volume drops below 10 μL, capillary action of the well can draw the sample to the corners of the well (FIG. 1B), rendering the sample unreadable.

Low volume reads are important because it conserves precious samples or costly reagents. There are some low volume spectrophotometry products on the market. One product is from Nanodrop™ that permits measurement of samples between 1.0 μL and 2 μL. The reading is slow and laborious. The most commonly used Nanodrop™ device reads one sample at a time (˜$9000) and the largest machine can only read a maximum eight samples at a time (˜$25,000). Another product on the market is the Infinite® Nanoquant device. It is a quartz-based device that can be inserted into some plate readers. The plate is cheaper, but the device is still expensive (˜$1000), and it can only read up to 16 samples at a time.

Accordingly, there is a need in the art for low-cost systems and methods for performing spectrophotometry measurements on low-volume samples.

### SUMMARY

The inventor has discovered, inter alia, that a layer of porous matrix, placed on the bottom of a well in a multiwell plate, permits a low-volume liquid sample to distribute evenly across the porous matrix, thus rendering the sample measurable by a spectrophotometric instrument such as a standard plate reader. Surprisingly, even when the liquid sample is as small as 1 μL or less, the inventor discovered that spectrophotometry measurements can still be performed on the sample to yield accurate results using the modified multiwell plate design disclosed herein. And thus the technology described herein provides a low-cost solution to low-volume spectrophotometric measurements. The solution also offers high throughput capabilities and easy integration with existing laboratory infrastructure. Furthermore, this approach also offers a way to make these measurements over time to track the progress of a reaction, a feature not currently available in other commercial products for low-volume spectrophotometric measurements.

Accordingly, in one aspect, a multiwell plate is provided herein, where the multiwell plate comprises a frame portion and a plurality of wells, each well comprising side walls and a bottom, wherein the bottom of at least one well (a) has a layer of porous matrix disposed thereon, or (b) is comprised of a layer of porous matrix, whereby the porous matrix permits a liquid sample of no more than 5 μL to distribute evenly across the porous matrix.

In one embodiment, the bottom of at least 50% of the wells (a) has a layer of porous matrix disposed thereon, or (b) is comprised of the layer of porous matrix.

In one embodiment, the layer of porous matrix is immobilized on the bottom of the well.

In one embodiment, the frame portion is comprised of plastic, resin, glass, or quartz.

In one embodiment, the plastic is polystyrene, polycarbonate, cyclo-olefin, or polypropylene.

In one embodiment, the bottom of the well is substantially flat.

In one embodiment, the bottom of the well is transparent or translucent.

In one embodiment, the porous matrix is transparent or translucent when wet.

In one embodiment, the porous matrix comprises a hydrophilic material.

In one embodiment, the hydrophilic material is selected from a group consisting of glass wool, a biopolymer, a synthetic polymer, mixed cellulose esters, textile, paper, quartz microfiber, aluminum oxide, and a combination thereof.

In one embodiment, the porous matrix is a mesh, a foam, a fibrous structure, a gel, a bed of beads, a sponge, a patterned surface, a 3-dimensional scaffold, or a membrane.

In one embodiment, the porous matrix is produced by the process of lyophilization.

In one embodiment, the porous matrix further comprises a synthetic gene network or an enzyme preparation.

In one embodiment, the multiwell plate comprises 6, 12, 24, 48, 72, 96, 384, or 1536 wells.

In one embodiment, the multiwell plate is configured to fit a standard plate reader.

In another aspect, a method is provided herein for performing a photometric or spectrophotometric measurement on a liquid sample having a small volume, the method comprising: (i) placing the liquid sample on a layer of porous matrix disposed on a bottom of a well in a multiwell plate, whereby the porous matrix permits the liquid sample to distribute evenly across the porous matrix; (ii) projecting a light beam onto the liquid sample distributed in the porous matrix; and (iii) measuring an output optical signal as a function of an interaction between the light beam and the liquid sample.

In one embodiment, the liquid sample has a volume of no more than 20 μL.

In one embodiment, the liquid sample has a volume of no more than 10 μL.

In one embodiment, the liquid sample has a volume of no more than 5 μL.

In one embodiment, the liquid sample has a volume of no more than 2 μL.

In one embodiment, the porous matrix is transparent or translucent when wet.

In one embodiment, the porous matrix comprises a hydrophilic material.

In one embodiment, the hydrophilic material is selected from a group consisting of glass wool, a biopolymer, a synthetic polymer, mixed cellulose esters, textile, paper, quartz microfiber, aluminum oxide, and a combination thereof.

In one embodiment, the porous matrix is a mesh, a foam, a fibrous structure, a gel, a bed of beads, a sponge, a patterned surface, a 3-dimensional scaffold, or a membrane.

In one embodiment, the method further comprises before step (i), a step of pre-treating the porous matrix with a blocking agent.

In one embodiment, the blocking agent is bovine serum albumin, polyethylene glycol, Tween-20, Triton-X, milk powder, casein, fish gelatin, salmon sperm DNA, or a combination thereof.

In one embodiment, the photometric or spectrophotometric measurement is performed by a plate reader.

In one embodiment, the output optical signal is absorbance.

In one embodiment, the light beam has a wavelength of less than 400 nm, and the absorbance measurement measures a concentration of nucleic acids in the liquid sample.

In one embodiment, the output optical signal is fluorescence.

In one embodiment, the output signal is luminescence.

In one embodiment, the liquid sample is not in contact with a cover plate during measurement.

In one embodiment, the method further comprising placing a transparent cover over the well to prevent or reduce evaporation.

In one embodiment, the photometric or spectrophotometric measurement is continuous over a period of time.

### BRIEF DESCRIPTION OF THE DRAWINGS

FIG. 1A is a diagram showing cross section of a conventional multiwell plate.

FIG. 1B is a diagram showing that, in the absence of the matrix, capillary action of the well of a conventional multiwell plate draws low-volume samples to the corners, making them unreadable.

FIG. 2A is a diagram showing cross section of a matrix-assisted multiwell plate according to some embodiments. The capillary action of the matrix holds the low volume sample in an even layer across the well/light beam for reliable measurement.

FIG. 2B is a diagram showing a top-down view of a matrix-assisted multiwell plate according to some embodiments.

FIGS. 3A-3D are images of matrix-assisted reactions in 384 well plates. (FIG. 3A) Fluorescent biomolecular reactions to screen for synthetic gene circuit performance. (FIG. 3B) Color-based reactions measured in absorbance mode on the plate readers. (FIG. 3C) >100 reactions read in fluorescence-mode on the plate reader. (FIG. 3D) 240 reactions colorimetric reactions read in absorbance mode. Experiment was run overnight with absorbance measurements taken every 10 min.

FIGS. 4A-4F are plots showing time course measurements from low volume matrix-assisted reactions with outputs in multiple fluorescent and absorbance modes. (FIG. 4A) GFP fluorescence 485 nm excitation/515 nm emission, (FIG. 4B) Venus fluorescence 510 nm/540 nm, (FIG. 4C) mCherry fluorescence 585 nm/615 nm, (FIG. 4D) Cerulean fluorescence 433 nm/475 nm, (FIG. 4E) 570 nm absorbance, (FIG. 4F) 410 nm absorbance.

FIG. 5 is a diagram showing cross section of quartz-based, matrix-assisted spectrophotometry plates according to some embodiments.

FIG. 6 is a plot showing comparison of solution and quartz-matrix phase measurement of DNA concentration. Absorbance measurement data from quartz-matrix reactions is processed to account for the dilution factor of DNA by the matrix.

FIGS. 7A-7B are heat maps of GFP expression over a time course for toehold switch orthogonality screens performed in a multiwell plate. The toehold switch is a type of synthetic gene network. (FIG. 7A) First 60 minutes of the orthogonality screen for GFP expressing toehold switches on paper. (FIG. 7B) First 60 minutes of the orthogonality screen for GFP expressing toehold switches on quartz microfiber.

### DETAILED DESCRIPTION

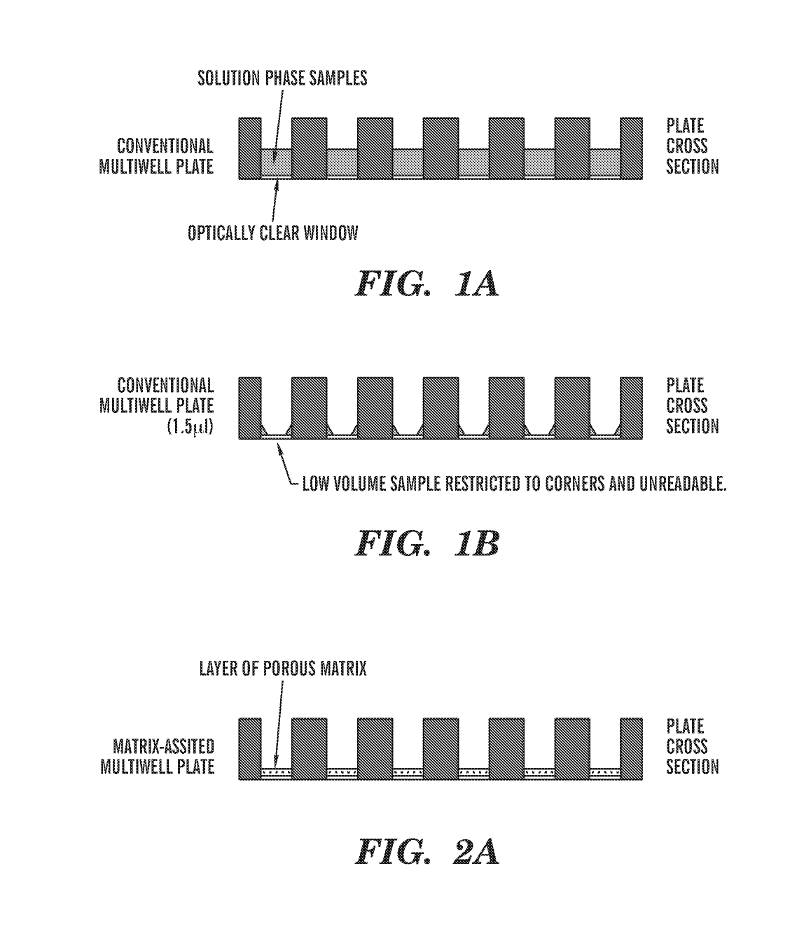

The technology described herein takes advantage of the ability of a porous matrix to distribute low-volume liquid evenly across the porous matrix due to capillary action. It is demonstrated herein that the problem of a low-volume liquid sample being restricted to the corners of a well (FIG. 1B) can be overcome by placing a layer of porous matrix (e.g., paper) on the bottom of the well. Without wishing to be bound by theory, capillary action is primarily responsible for the distribution of liquid in the porous matrix. As the low-volume sample is impregnated inside the porous matrix, it can be measured by a spectrophotometric instrument such as a standard plate reader. The described multiwell plates and methods were developed to exploit this discovery, and can be broadly applicable in the area of spectrophotometry, particularly low-volume spectrophotometry.

The described multiwell plates and methods are low-cost, and can be compatible with existing laboratory infrastructure. Conventional multiwell plates are low-cost and common items in the laboratory. Current methods to manufacture these multiwell plates can be modified to produce the described multiwell plates. Similarly, plate readers are also common in the laboratory. As the described multiwell plates can be read by a standard plate reader, the methods described herein also provide high throughput capabilities, i.e., measuring a plurality of samples (e.g., at least 2, at least 5, at least 10, at least 20, at least 100, at least 500) simultaneously.

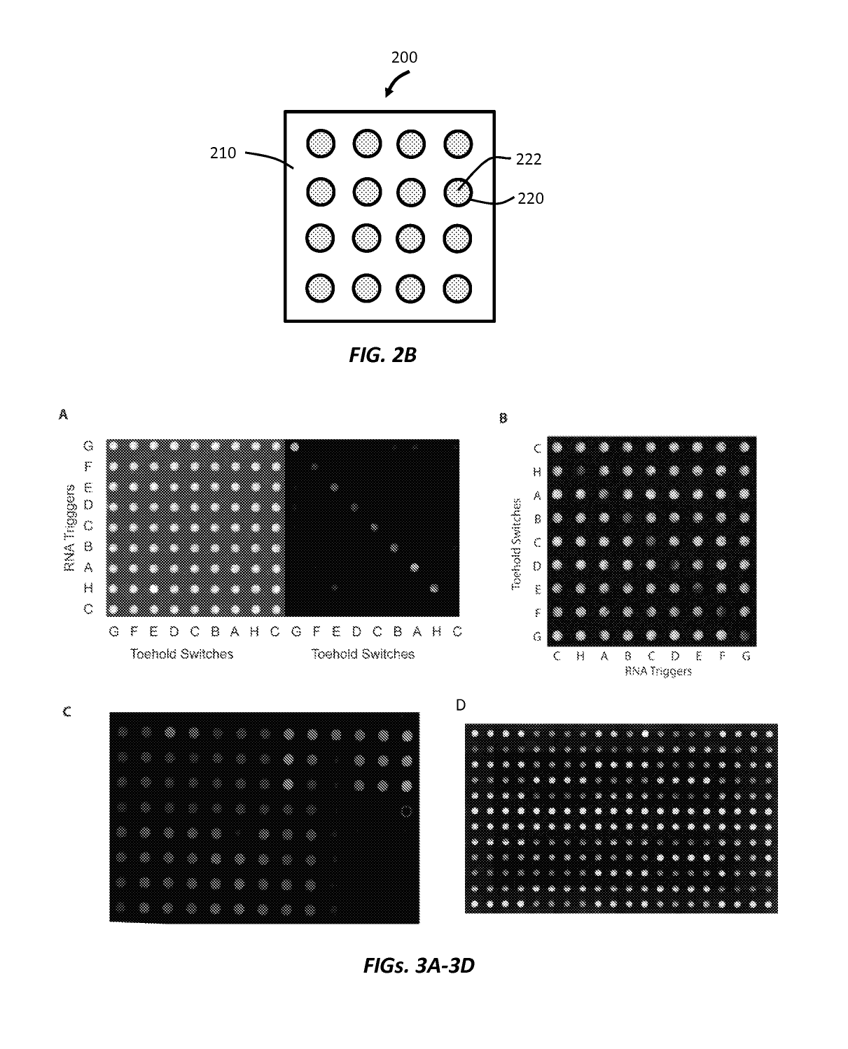

One aspect of the technology described herein relates to a multiwell plate comprising a frame portion and a plurality of wells, each well comprising side walls and a bottom, where the bottom of at least one well (e.g., 2, 3, 4, 5, 6, 7, 8, 9, or more) has a layer of porous matrix disposed thereon. An exemplary embodiment is shown in FIG. 2A.

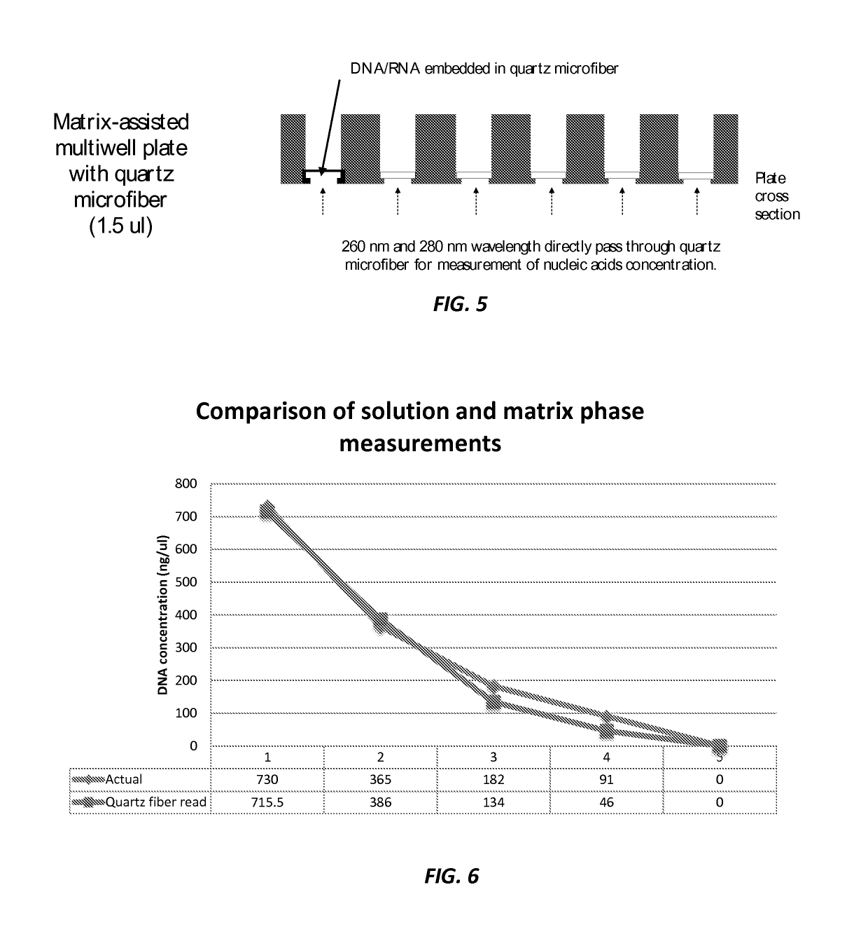

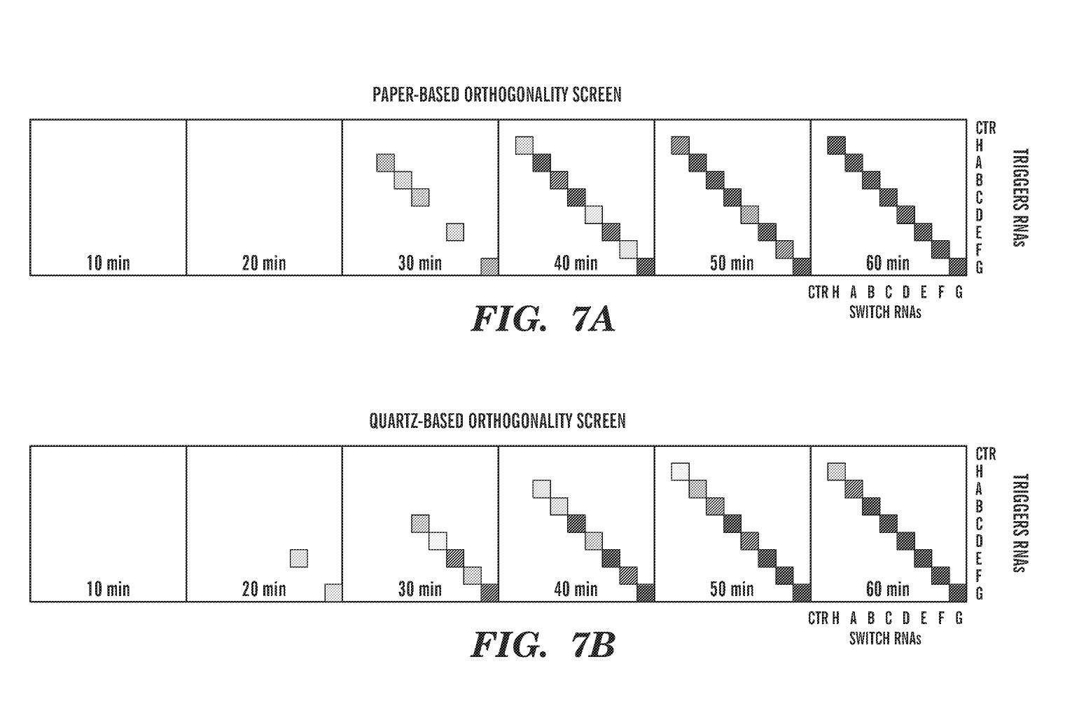

In another embodiment, a multiwell plate comprises a frame portion and a plurality of wells, each well comprising side walls and a bottom, where the bottom of at least one well (e.g., 2, 3, 4, 5, 6, 7, 8, 9, or more) is comprised of a layer of porous matrix. An exemplary embodiment is shown in FIG. 5. The multiwell plate can optionally comprise a base portion below the wells. The base portion is configured to ensure that samples are not contaminated from below and reduce evaporation.

FIG. 2B is a diagram showing a top-down view of a multiwell plate 200 according to some embodiments. The multiwell plate 200 comprises a frame portion 210, a plurality of wells 220 defined by the frame portion 210, and a layer of porous matrix 222 confined within the wells 220. As described previously, the layer of porous matrix 222 can be disposed on and in contact with the bottom of the well, or alternatively, it can form the bottom of the well.

The porous matrix permits a low-volume liquid sample to distribute evenly across the layer of porous matrix. As used herein, the terms “low-volume” or “low volume” refer to a liquid volume of no more than 20 μL (i.e., 20 μL or less) and greater than 0 μL. The terms encompass, for example, a liquid volume of no more than 15 μL, no more than 10 μL, no more than 9 μL, no more than 8 μL, no more than 7 μL, no more than 6 μL, no more than 5 μL, no more than 4 μL, no more than 3 μL, no more than 2 μL, or no more than 1 μL. The liquid volume can be in the range of 0.1 μL to 20 μL, 0.5 μL to 15 μL, or 1 μL to 10 μL.

In some embodiments, the porous matrix can have a porosity of at least about 5%, at least about 10%, at least about 20%, at least about 30%, at least about 40%, at least about 50%, at least about 60%, at least about 70%, at least about 80%, at least about 90% or higher, but excluding 100%. In some embodiments, the porosity can range from about 5% to about 80%, or from about 10% to about 60%. The pore size and total porosity values can be quantified using conventional methods and models known to those of skill in the art. For example, the pore size and porosity can be measured by standardized techniques, such as mercury porosimetry and nitrogen adsorption.

In one embodiment, the porous matrix is immobilized on the bottom of the well. The immobilization can be mechanical. For example, the layer of porous matrix can be securely pinned between a top layer and a bottom layer. The immobilization can be done using a chemical, such as an adhesive.

In some embodiments, at least 60%, at least 70%, at least 80%, at least 85%, at least 90%, or at least 95% of the area of the bottom of the well is covered by the layer of porous matrix.

In some embodiments, the bottom of at least 5%, at least 10%, at least 20%, at least 30%, at least 40%, at least 50%, at least 60%, at least 70%, at least 80%, or at least 90% of the wells of a plate has a layer of porous matrix disposed thereon, or is comprised of a layer of porous matrix.

It should be noted that in some embodiments, a patterned surface can be used instead of a porous matrix. Without wishing to be bound by theory, patterned surfaces can also permit the dispersion of a low-volume liquid sample by reducing surface tension. A patterned surface can be physically or chemically patterned, or both. A physically patterned surface is textured, and can comprise nano-patterns, micro-patterns, or both. A chemically patterned surface typically comprises hydrophilic molecules and/or hydrophobic molecules attached to the surface. For example, a hydrophobic surface can be patterned with hydrophilic molecules to render certain regions hydrophilic. Methods of producing physically or chemically patterned surfaces are well known in the art.

The configuration (e.g., number of wells, diameter of the wells, height of the wells, spacing between the wells, etc.) of conventional multiwell plates can provide useful guidance in determining the configuration of the multiwell plates described herein. In some embodiments, the multiwell plates are substantially similar to conventional multiwell plates. As an example, a typical 96-well plate comprises 96 wells, each of which has a diameter of 6.4 mm. In one embodiment, the multiwell plate is configured to fit a standard plate reader. Current multiwell plates in the market are available through companies such as Sigma-Aldrich, VWR, Thermo Scientific, Corning and Roche.

The number of wells can be at least 1, at least 2, at least 5, at least 10, at least 20, at least 50, at least 100, at least 200, at least 500, or at least 1000. In one embodiment, the multiwell plate comprises 6 wells. In one embodiment, the multiwell plate comprises 12 wells. In one embodiment, the multiwell plate comprises 24 wells. In one embodiment, the multiwell plate comprises 48 wells. In one embodiment, the multiwell plate comprises 96 wells. In one embodiment, the multiwell plate comprises 384 wells. In one embodiment, the multiwell plate comprises 1536 wells.

The diameters of the wells do not have to be the same. Preferably, the well diameters are uniform across the multiwell plate. The well diameter should be such that it can contain a low-volume liquid sample and ensure that the liquid sample, when impregnated in the porous matrix, can distribute across the layer of porous matrix.

In one embodiment, the bottom of the well is substantially flat or planar.

In one embodiment, the bottom of the well permits a portion of light having a particular wavelength or wavelength range to pass through. The portion of light can be at least 10%, at least 20%, at least 30%, at least 40%, at least 50%, at least 60%, at least 70%, at least 75%, at least 80%, at least 85%, at least 90%, or at least 95%.

In one embodiment, the bottom of the well is transparent or translucent. As used herein, the terms “transparent” “translucent”, or “optically clear”, when used to refer to a material, mean that at least 70%, at least 75%, at least 80%, at least 85%, or at least 90% of light having a particular wavelength or wavelength range can pass through the material. The terms “transparent”, “translucent”, or “optically clear” are used interchangeably herein. It is known in the art that a material can be transparent for some wavelengths but not others. For example, polystyrene, commonly used in the manufacturing of multiwell plates, is transparent in the visible wavelength range. Quartz is transparent in the visible and ultraviolet range.

It should be noted that the multiwell plates described herein are not intended to be used for filtering. In some embodiments of a well bottom having a layer of porous matrix disposed thereon, the well bottom is free of holes. This is in contrast to conventional multiwell filter plates (see e.g., U.S. Pat. No. 6,391,241), which comprise a filter in each well and a hole in the well bottom.

The frame portion can be comprised of a variety of materials. In some embodiments, the frame portion also includes the well bottoms, and the frame portion is comprised of a material transparent for a desirable wavelength or wavelength range. In one embodiment, the frame portion is comprised of plastic or resin, such as polystyrene, polycarbonate, cyclo-olefin, and polypropylene. In one embodiment, the frame portion is comprised of glass. In one embodiment, the frame portion is comprised of quartz. In some embodiments, the frame portion can be comprised of a material different from that of the well bottoms.

The porous matrix can be comprised of a variety of materials, provided that such material permits a portion of light having a particular wavelength or wavelength range to pass through. The portion of light can be at least 10%, at least 20%, at least 30%, at least 40%, at least 50%, at least 60%, at least 70%, at least 75%, at least 80%, at least 85%, at least 90%, or at least 95%. In one embodiment, the porous matrix is comprised of a material transparent when wet (i.e., impregnated with a liquid) but not necessarily transparent before wetting. The porous matrix can be in a variety of forms including, but not limited to, a mesh, a foam, a fibrous structure, a gel, a bed of beads, a sponge, a patterned surface, a 3-dimensional scaffold, and a membrane.

The porous matrix layer should be thick enough to evenly distribute a low-volume liquid sample, and should not be so thick that excess material is present. In some embodiments, the thickness of the porous matrix layer is no more than 800 μm, no more than 700 μm, no more than 600 μm, no more than 500 μm, no more than 400 μm, no more than 300 μm, no more than 200 μm, no more than 100 μm, no more than 80 μm, no more than 50 μm, or no more than 25 μm. In some embodiments, the thickness of the porous matrix layer is in the range of 100 nm to 800 μm, 100 nm to 500 μm, 100 nm to 400 μm, 100 nm to 300 μm, 100 nm to 200 μm, 200 nm to 200 μm, 300 nm to 200 μm, 400 nm to 200 μm, 500 nm to 200 μm, 1 μm to 200 μm, or 10 μm to 200 μm. In some embodiments of using a patterned surface for liquid distribution, the patterned surface can have a profile of less than 50 μm, e.g., tens of nanometers, hundreds of nanometers, or a few microns.

In one embodiment, the porous matrix is comprised of a hydrophilic material. Exemplary hydrophilic materials include, but are not limited to, glass wool, a biopolymer (e.g., silk or cellulose), a synthetic polymer, mixed cellulose esters, textile, paper, quartz microfiber, aluminum oxide.

In one embodiment, the porous matrix comprises paper. Papers applicable in the technology described herein can include, but not limited to, printing paper, wrapping paper, writing paper, drawing paper, specialty paper (for example, chromatography paper, filter paper, e.g., Whatman™ filter paper), handmade paper, or blotting paper. The use of paper confers several advantages: low cost, light weight, and thin cross section.

In one embodiment, the porous matrix further comprises an agent. The agent can be reactive or inert towards the liquid sample. The agent can be a chemical compound or a biological composition. The agent can be lyophilized onto the porous matrix.

In one embodiment, the agent is a synthetic biological circuit. The term “synthetic biological circuit” is used herein to refer to any engineered biological circuit where the biological components are designed to perform logical functions. In general, an input is needed to activate a synthetic biological circuit, which subsequently produces an output as a function of the input. In some embodiments, a synthetic biological circuit comprises at least one nucleic acid material or construct. In some embodiments, a synthetic biological circuit is substantially free of nucleic acids. A synthetic gene network is one kind of synthetic biological circuit. Other examples of synthetic biological circuits include, but are not limited to, an engineered signaling pathway, such as a pathway that amplifies input via kinase activity.

In one embodiment, the agent is a synthetic gene network. Since the inception of synthetic biology, a wide variety of synthetic gene networks have been demonstrated, and any synthetic gene network can be embedded in the porous matrix, including, but not limited to a sensor, a switch, a counter, a timer, a converter, a toggle, a logic gate (e.g., AND, NOT, OR, NOR, NAND, XOR, XAND, XNOR, A IMPLY B, A NIMPLY B, B IMPLY A, B NIMPLY A, or a combination thereof), or a memory device (e.g., volatile or non-volatile). Examples of synthetic gene networks can be found in U.S. Pat. No. 6,737,269, US20100175141, US20120003630, US20130009799, US20130034907, and WO2014093852, the contents of each of which are incorporated by reference in their entirety. For example, WO2014093852 describes 16 logic gates based on synthetic gene networks: AND, OR, NOT A, NOT B, NOR, NAND, XOR, XNOR, A IMPLY B, B IMPLY A, A NIMPLY B, B NIMPLY A, A, B, FALSE and TRUE. Methods of constructing synthetic gene networks are also disclosed, for example, in Synthetic Gene Networks, Weber and Fussenegger (Eds.) 2012, Humana Press, the contents of which are incorporated by reference in their entirety.

In one embodiment, the agent is an enzyme preparation. As used herein, the term “enzyme preparation” refers to a composition comprising at least one of the selected or desired enzyme. The preparation may contain the enzymes in at least partially purified and isolated form. The preparation can be a spent culture medium. The preparation can contain additives, such as mediators, stabilizers, buffers, preservatives, surfactants and/or culture medium components. Preferred additives include those commonly used in enzyme preparations intended for a particular application.

In one embodiment, the agent is a cell-free system. As used herein, the term “cell-free system” refers to a set of reagents capable of providing for or supporting a biosynthetic or enzyme-mediated reaction (e.g., transcription reaction, translation reaction, or both) in vitro in the absence of cells. For example, to provide for a transcription reaction, a cell-free system comprises promoter-containing DNA, RNA polymerase, ribonucleotides, and a buffer system. Cell-free systems can be prepared using enzymes, coenzymes, and other subcellular components either isolated or purified from eukaryotic or prokaryotic cells, including recombinant cells, or prepared as extracts or fractions of such cells. A cell-free system can be derived from a variety of sources, including, but not limited to, eukaryotic and prokaryotic cells, such as bacteria including, but not limited to, E. coli, thermophilic bacteria and the like, wheat germ, rabbit reticulocytes, mouse L cells, Ehrlich's ascitic cancer cells, HeLa cells, CHO cells and budding yeast and the like.

The multiwell plates disclosed herein can be for general use, as well as for spectrophotometric measurements such as fluorescence, absorbance, and luminescence. The multiwell plates, particularly the frame portion, can be colored, depending on the applications. For example, the frame portion can be white, which can help reflect luminescence signals; or the frame portion can be black, which can help ensure that there is no signal crosstalk between neighboring wells.

The multiwell plates disclosed herein can be manufactured using conventional methods known in the art, such as molding (e.g. injection molding), machining (e.g., including mechanical cutting, laser cutting), extruding, embossing, and solid free-form fabrication technologies (e.g., three dimensional printing and stereolithography).

In one embodiment, the porous matrix layers can be deposited on the well bottoms after the frame portion is manufactured. For example, individual discs of porous matrix can be punched from a sheet of porous material. These discs correspond to the shape of the cross section of the well and therefore likewise may be circular, oval, square, rectangular, etc. as punched from an accordingly shaped punch unit. In one example, each disc can be inserted into each well; if desired, the discs can be immobilized on the well bottoms by an adhesive (e.g., glue or epoxy).

In one embodiment, the porous matrix layers can be deposited on the well bottoms of a multiwell plate by a water-removal process such as lyophilization. For example, a slurry is introduced to each of the well bottoms, and lyophilization is used to remove the water, leaving behind a thin layer of porous matrix.

In one embodiment, the porous matrix layers can be positioned on the well bottoms or as the well bottoms during the manufacturing process of the frame portion. For example, the multiwell plate can be manufactured by bonding a top layer and a bottom layer together, where the individual discs of porous matrix are aligned to the well bottoms prior to the bonding; the discs can be securely pinned between the opposing layers as a result of the bonding. The bonding of the top layer and the bottom layer also defines the frame portion.

Other methods of manufacturing multiwell plates are also disclosed, for example, in U.S. Pat. No. 4,948,442, U.S. Pat. No. 5,047,215, U.S. Pat. No. 6,391,241, U.S. Pat. No. 6,767,607, US20050170498, and US20030183958, the contents of each of which are incorporated herein by reference in their entirety.

Another aspect of the technology disclosed herein relates to a method of performing a photometric or spectrophotometric measurement on a low-volume liquid sample. The method comprises the steps of (i) placing the liquid sample on a layer of porous matrix disposed on a bottom of a well in a multiwell plate, (ii) projecting a light beam onto the liquid sample distributed in the porous matrix, and (iii) measuring an output optical signal as a function of an interaction between the light beam and the liquid sample. The method described herein can be performed on the multiwell plates described herein. Alternatively, the method described herein can be performed on conventional multiwell plates that are modified, for example, by placing paper on the bottom of the well. The liquid sample can be an aqueous sample or a sample in an organic solvent.

In one embodiment, the method further comprises, before step (i), a step of pre-treating the porous matrix with a blocking agent. Examples of the blocking agent include, but are not limited to, a protein source (e.g., bovine serum albumin, milk powder, casein, or fish gelatin), salmon sperm DNA, polyethylene glycol, a surfactant (e.g., polysorbate 20 or Triton-X), or a combination thereof. Without wishing to be bound by theory, this pre-treatment step can increase the signal-over-noise ratio for a fluorescent signal by limiting non-specific binding and/or irreversible binding of the reaction components.

In one embodiment, the method further comprises a step of creating a humid environment in the multiwell plate, which can help prevent or slow the liquid sample from drying out during the measurement. For example, some wells of the multiwell plate can contain water in order to increase the humidity in the entire multiwell plate. Optionally, a transparent cover can be used to maintain the humidity. In another example, humid gas, e.g., having at least 50%, at least 60%, at least 70% humidity, or at least 80% humidity, can be utilized to create a humid environment in the multiwell plate. In one embodiment, the liquid sample is not in contact with a cover plate during measurement.

In one embodiment, the photometric or spectrophotometric measurement is an absorbance measurement. Methods and systems for measuring the absorbance of a liquid sample are known to a person skilled in the art. Generally, a light beam, either broadband or of a particular wavelength, is projected onto the liquid sample. Due to its interaction with the liquid sample, a portion of the light is absorbed and reflected by the liquid sample. By measuring the light exiting from the liquid sample, one can then obtain an absorbance spectrum. Well known in the art, the Beer-Lambert law describes the relationship between the sample concentration and the amount of light being absorbed.

In one embodiment, the photometric or spectrophotometric measurement is a fluorescence measurement. Methods and systems for measuring the fluorescence property of a liquid sample are known to a person skilled in the art. In general, a light beam having a particular wavelength is projected onto the liquid sample. Due to its interaction with the liquid sample, the liquid sample produces fluorescence which has a distinctly different wavelength from that of the incident light beam.

Without limitation, other examples of photometric or spectrophotometric measurements include luminescence measurements, time-resolved fluorescence measurements, fluorescence polarization measurements, light scattering measurements, plasmonic measurements, ultraviolet spectrophotometry, infrared or near-infrared spectrophotometry. In one embodiment, the photometric or spectrophotometric measurement is not Raman spectroscopy.

The properties of the light beam depend on the specific measurement. For example, the light beam can be collimated or diffused. Without limitation, the wavelength of the light beam can be in the ultraviolet range, the visible range, the near-infrared range, or the infrared range.

In one embodiment, the photometric or spectrophotometric measurement is performed by a plate reader (also known as a microplate reader). Plate readers permit high throughput measurement on a plurality of samples (e.g., at least 2, at least 5, at least 10, at least 15, at least 20, at least 25, at least 30, at least 50, at least 100, or at least 200). Plate readers are commercially available through companies such as Tecan, Molecular Devices, Thermo Scientific, BioTek, and Bio-Rad.

Some porous matrices can produce unwanted background signals (e.g., absorbance or fluorescence) during photometric or spectrophotometric measurement. Accordingly, in one embodiment, the method further comprises a step of performing a control measurement on the porous matrix without the liquid sample or with a “blank” liquid sample without analyte. Control measurements can be used to measure the absorption or fluorescence properties of the porous matrix. Data gathered from the control measurements are then used to remove the background signals from the output optical signal when unknown or experimental samples are measured.

The liquid sample can comprise an analyte that can be measured by a photometric or spectrophotometric measurement. In one embodiment, the method disclosed herein can be used to measure the concentration of nucleic acids in a liquid sample. Nucleic acids absorb light at 260 nm, and proteins absorb light at 280 nm. Commonly used approaches to evaluate the concentration and relative purity of nucleic acid preparation measure at both 260 nm and 280 nm and express the value as a ratio. Thus, absorbance measurements of nucleic acids generally require that the light beam has a wavelength of 260 nm and/or 280 nm. Due to its transparency at these wavelengths, quartz microfiber can be used as the porous matrix to permit measurement at wavelengths below 400 nm.

The methods disclosed herein can also be used to monitor/measure a chemical or biochemical reaction in a liquid sample. In one embodiment, the liquid sample comprises reactive components that are undergoing a chemical or biochemical reaction. In another embodiment, the liquid sample comprises a component that can react with one or more compounds on the porous matrix. In yet another embodiment, a second liquid sample is added to the porous matrix impregnated with the first liquid sample, where the first liquid sample comprises a component that can react with another component in the second liquid sample. Chemical or biochemical reactions applicable herein include any reaction which can produce a change in an optical signal, e.g., an increase in the intensity of the optical signal, a reduction in the intensity of the optical signal, or a change in the wavelength or polarization of the optical signal. Exemplary chemical or biochemical reactions include, but are not limited to, condensation, acylation, dimerization, alkylation, rearrangement, transposition, decarbonylation, coupling, aromatization, epoxidation, disproportionation, hydrogenation, oxidation, reduction, substitution, isomerization, stereoisomerization, functional group conversion, functional group addition, elimination, bond cleavage, photolysis, photodimerization, cyclization, hydrolysis, polymerization, binding, such as between a receptor and a ligand; inhibition, such as between an enzyme and an inhibitor; recognition, such as between an antibody and a hapten; activation, such as between an agonist and a receptor; inactivation, such as between an antagonist and a receptor; protein synthesis; enzyme-mediated reactions; interactions between biomolecules (including nucleic acids), and the like.

In one embodiment, the methods disclosed herein can also be used for drug discovery using protein targets or whole cells, screens for protein function, in vitro engineering and assembly of metabolic pathways, and combinatorial chemistry. In some embodiments, biological cells can be grown on, within, or under the porous matrix.

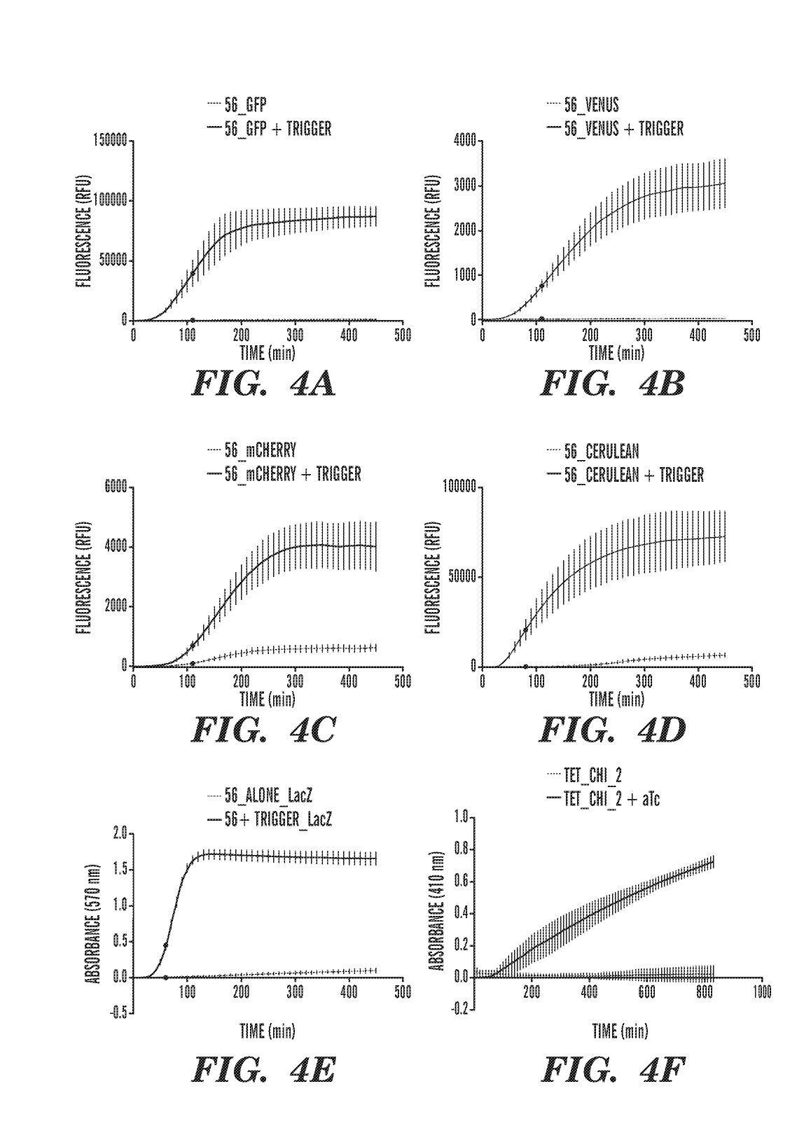

In one embodiment, the photometric or spectrophotometric measurement is made periodically continuous over a period of time. The period of time can be on the order of seconds, minutes, or hours, depending upon the exact measurement. This can be particularly advantageous for monitoring reaction kinetics. In one embodiment, a reaction curve can be generated for accumulation of signal. For example, see FIGS. 4 & 7.

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities of ingredients or reaction conditions used herein should be understood as modified in all instances by the term “about.”

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Although any known methods, devices, and materials may be used in the practice or testing of the invention, the methods, devices, and materials in this regard are described herein.

### Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are useful to an embodiment, yet open to the inclusion of unspecified elements, whether useful or not.

As used herein the term “consisting essentially of” refers to those elements required for a given embodiment. The term permits the presence of elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

As used herein, the term “porous matrix” refers to a matrix that contain pores or interstices via which a liquid composition may penetrate the matrix surface. Paper is one example of a porous matrix.

As used herein, the terms “porous” and “porosity” are generally used to describe a structure having a connected network of pores or void spaces (which can, for example, be openings, interstitial spaces or other channels) throughout its volume. The term “porosity” is a measure of void spaces in a material, and is a fraction of volume of voids over the total volume, as a percentage between 0 and 100% (or between 0 and 1).

As used herein, the terms “distributes evenly” or “evenly distributed” refer to the manner of spreading of a liquid aqueous solution or sample on or into a solid (or porous solid) surface or surface layer. A solution that “distributes evenly” will spread across the surface of a solid to substantially wet the surface or surface layer without beading and without significant voids in the surface wetting. Capillary action and interfacial tension can contribute to the even spreading of liquids—when the force of interaction with the surface is greater than the cohesive forces within the liquid, a drop of liquid will tend to spread on the surface, rather than remain as a bead or droplet unevenly distributed on or in the surface. Thus, a surface or surface layer comprised of hydrophilic material will tend to promote even distribution of liquids over such surface or layer. The contact angle between water and a given surface provides a useful measure of hydrophilicity—generally a surface that provides a contact angle of less than 90° with a droplet of water or aqueous sample solution is considered hydrophilic and will promote even distribution of an aqueous sample. It is noted that surfactant or plasma treatment of an otherwise hydrophobic surface or material can modify the interaction of such surface or material with water or aqueous sample, promoting even distribution.

As used herein, the term “sample,” means any sample comprising or being tested for the presence of one or more analytes. Unless otherwise specified, a “sample” will be in aqueous solution or suspension. Such samples include, without limitation, those derived from or containing cells, organisms (bacteria, viruses), lysed cells or organisms, cellular extracts, nuclear extracts, components of cells or organisms, extracellular fluid, media in which cells or organisms are cultured in vitro, blood, plasma, serum, gastrointestinal secretions, ascites, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears, pleural fluid, nipple aspirates, breast milk, external secretions of the skin, respiratory, intestinal, and genitourinary tracts, and prostatic fluid. A sample can be a viral or bacterial sample, a sample obtained from an environmental source, such as a body of polluted water, an air sample, or a soil sample, as well as a food industry sample. A sample can be derived from a chemical reaction. A sample can be a biological sample which refers to the fact that it is derived or obtained from a living organism. The organism can be in vivo (e.g. a whole organism) or can be in vitro (e.g., cells or organs grown in culture). In one embodiment, a “biological sample” also refers to a cell or population of cells or a quantity of tissue or fluid from a subject. Often, a “biological sample” will contain cells from a subject, but the term can also refer to non-cellular biological material, such as non-cellular fractions of blood, saliva, or urine, that can be used to measure analyte or enzyme activity levels, for example, upon rehydration. Biological samples also include explants and primary and/or transformed cell cultures derived from patient tissues. A biological sample can be provided by removing a sample of cells from subject, but can also be accomplished by using previously isolated cells or cellular extracts (e.g., isolated by another person, at another time, and/or for another purpose). Archival tissues, such as those having treatment or outcome history may also be used. Biological samples include, but are not limited to, tissue biopsies, scrapes (e.g. buccal scrapes), urine, or cell culture. Biological samples also include tissue biopsies, cell culture. The term “sample” also includes untreated or pretreated (or pre-processed) samples. For example, a sample can be pretreated to increase analyte concentration. A low-volume liquid sample can also be pretreated to increase the volume, for example, by using a bulking agent.

As used herein, the term “analyte” refers to a biological substance or chemical compound of interest, or a group or mixture of such substances or compounds. Examples of an analyte include, but are not limited to, a small inorganic or organic molecule, an ion, a nucleic acid (e.g., DNA, RNA), a polypeptide, a peptide, a metabolic product, a hormone, an antigen, an antibody, a biological cell, a virus, and a liposome.

As used herein, the terms “nucleic acid,” “polynucleotide,” and “oligonucleotide” are used interchangeably to generally refer to any polyribonucleotide or poly-deoxyribonucleotide, and includes unmodified RNA, unmodified DNA, modified RNA, and modified DNA. Polynucleotides include, without limitation, single- and double-stranded DNA and RNA polynucleotides. The term “nucleic acid” embraces chemically, enzymatically or metabolically modified forms of polynucleotides, as well as the naturally occurring chemical forms of DNA and RNA found in or characteristic of viruses and cells, including for example, simple (prokaryotic) and complex (eukaryotic) cells. A nucleic acid polynucleotide or oligonucleotide as described herein retains the ability to hybridize to its cognate complimentary strand. An oligonucleotide is not necessarily physically derived from any existing or natural sequence, but can be generated in any manner, including chemical synthesis, DNA replication, DNA amplification, in vitro transcription, reverse transcription or any combination thereof.

“Synthetic gene network” or “synthetic gene circuit” are used interchangeably herein to refer to an engineered composition that comprises at least one nucleic acid material or construct and can perform a function including, but not limited to, sensing, a logic function, and a regulatory function. The nucleic acid material or construct can be naturally occurring or synthetic. The nucleic acid material or construct can comprise DNA, RNA, or an artificial nucleic acid analog thereof. In some embodiments of a synthetic gene network comprising at least two nucleic acid materials or constructs, the nucleic acid materials or constructs can interact with each other directly or indirectly. An indirect interaction means that other molecules are required for or intermediate in the interaction. Some examples of synthetic gene networks comprise a nucleic acid operably linked to a promoter.

The term “biosynthetic reaction” is used herein to refer to any reaction that results in the synthesis of one or more biological compounds (e.g., DNA, RNA, proteins, monosaccharides, polysaccharides, etc.). For example, a transcription reaction is a biosynthetic reaction because RNA is produced. Other examples of biosynthetic reactions include, but are not limited to, translation reactions, coupled transcription and translation reactions, DNA synthesis, and polymerase chain reactions.

Other than in the operating examples, or where otherwise indicated, all numbers expressing quantities of ingredients or reaction conditions used herein should be understood as modified in all instances by the term “about.” The term “about” when used in connection with percentages may mean±5% of the value being referred to. For example, about 100 means from 95 to 105.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow. Further, to the extent not already indicated, it will be understood by those of ordinary skill in the art that any one of the various embodiments herein described and illustrated can be further modified to incorporate features shown in any of the other embodiments disclosed herein.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The present invention may be as defined in any one of the following numbered paragraphs or in any combination of the following numbered paragraphs:
1. A multiwell plate comprising a frame portion and a plurality of wells, each well comprising side walls and a bottom, wherein the bottom of at least one well (a) has a layer of porous matrix disposed thereon, or (b) is comprised of a layer of porous matrix, whereby the porous matrix permits a liquid sample of no more than 5 μL to distribute evenly across the porous matrix.
2. The multiwell plate of paragraph 1, wherein the bottom of at least 50% of the wells (a) has a layer of porous matrix disposed thereon, or (b) is comprised of a layer of porous matrix.
3. The multiwell plate of paragraph 1 or 2, wherein the layer of porous matrix is immobilized in the well.
4. The multiwell plate of paragraph 1, 2, or 3, wherein the layer of porous matrix is immobilized on the bottom of the well.
5. The multiwell plate of any one of paragraphs 1-4, wherein the frame portion is comprised of plastic, resin, glass, or quartz.
6. The multiwell plate of any one of paragraphs 1-5, wherein the plastic is polystyrene, polycarbonate, cyclo-olefin, or polypropylene.
7. The multiwell plate of any one of paragraphs 1-6, wherein the bottom of the well is substantially flat.
8. The multiwell plate of any one of paragraphs 1-7, wherein the bottom of the well is transparent or translucent.
9. The multiwell plate of any one of paragraphs 1-8, wherein the porous matrix is transparent or translucent when wet.
10. The multiwell plate of any one of paragraphs 1-9, wherein the porous matrix comprises a hydrophilic material.
11. The multiwell plate of paragraph 10, wherein the hydrophilic material is selected from a group consisting of glass wool, a biopolymer, a synthetic polymer, mixed cellulose esters, textile, paper, quartz microfiber, aluminum oxide, and a combination thereof
12. The multiwell plate of any one of paragraphs 1-11, wherein the porous matrix is a mesh, a foam, a fibrous structure, a gel, a bed of beads, a sponge, a patterned surface, a 3-dimensional scaffold, or a membrane.
13. The multiwell plate of any one of paragraphs 1-12, wherein the porous matrix is produced by the process of lyophilization.
14. The multiwell plate of any one of paragraphs 1-13, wherein the porous matrix further comprises a synthetic gene network or an enzyme preparation.
15. The multiwell plate of any one of paragraphs 1-14, comprising 6, 12, 24, 48, 72, 96, 384, or 1536 wells.
16. The multiwell plate of any one of paragraphs 1-15, configured to fit a standard plate reader.
17. A method of performing a photometric or spectrophotometric measurement on a liquid sample having a small volume, the method comprising:
   (i) placing the liquid sample on a layer of porous matrix disposed on a bottom of a well in a multiwell plate, whereby the porous matrix permits the liquid sample to distribute evenly across the porous matrix;
   (ii) projecting a light beam onto the liquid sample distributed in the porous matrix; and
   (iii) measuring an output optical signal as a function of an interaction between the light beam and the liquid sample.
18. The method of paragraph 17, wherein the liquid sample has a volume of no more than 20 μL.
19. The method of paragraph 17, wherein the liquid sample has a volume of no more than 10 μL.
20. The method of paragraph 17, wherein the liquid sample has a volume of no more than 5 μL.
21. The method of paragraph 17, wherein the liquid sample has a volume of no more than 2 μL.
22. The method of any one of paragraphs 17-21, wherein the porous matrix is transparent or translucent when wet.
23. The method of any one of paragraphs 17-22, wherein the porous matrix comprises a hydrophilic material.
24. The method of paragraph 23, wherein the hydrophilic material is selected from a group consisting of glass wool, a biopolymer, a synthetic polymer, mixed cellulose esters, textile, paper, quartz microfiber, aluminum oxide, and a combination thereof
25. The method of any one of paragraphs 17-24, wherein the porous matrix is a mesh, a foam, a fibrous structure, a gel, a bed of beads, a sponge, a patterned surface, a 3-dimensional scaffold, or a membrane.
26. The method of any one of paragraphs 17-25, further comprising, before step (i), a step of pre-treating the porous matrix with a blocking agent.
27. The method of paragraph 26, wherein the blocking agent is bovine serum albumin, polyethylene glycol, Tween-20, Triton-X, milk powder, casein, fish gelatin, salmon sperm DNA, or a combination thereof
28. The method of any one of paragraphs 17-27, wherein the photometric or spectrophotometric measurement is performed by a plate reader.
29. The method of any one of paragraphs 17-28, wherein the output optical signal is absorbance.
30. The method of paragraph 29, wherein the light beam has a wavelength of less than 400 nm, and wherein the absorbance measurement measures a concentration of nucleic acids in the liquid sample.
31. The method of any one of paragraphs 17-28, wherein the output optical signal is fluorescence.
32. The method of any one of paragraphs 17-28, wherein the output signal is luminescence.
33. The method of paragraph 17, wherein the liquid sample is not in contact with a cover plate during measurement.
34. The method of any one of paragraphs 17-33, further comprising placing a transparent cover over the well to prevent or reduce evaporation.
35. The method of any one of paragraphs 17-34, wherein the photometric or spectrophotometric measurement is continuous over a period of time.

### EXAMPLES

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

The technology described herein is further illustrated by the following examples which in no way should be construed as being further limiting.

### Example 1: Measurement of Paper-Based Reactions

The technology disclosed herein can be used to measure sample fluorescence and absorbance of a sample, e.g., a sample comprising biomolecules. Results are comparable to conventional solution phase measurements for both single endpoint reads and overnight time course measurements. FIG. 3A-3D are images of 384 well plates showing the final results of the paper-based reactions.

Plate reader data from either fluorescence or absorbance modes yield reliable and consistent results. FIG. 4 shows matrix-assisted time course data for both modes. Data presented is the average of triplicate or quadruplicate experiments, while error bars representing standard deviation.

Paper has been the focus as the matrix for plate reader applications. It is low cost, easy to work with, highly absorbent, helps to reduce evaporation and becomes translucent when wet. It does however have background fluorescence in the green channel (GFP) and absorbs light below 400 nm. Despite these deficiencies, when used with proper controls to subtract background signal, paper serves as an excellent substrate for most measurements (controls are also important for conventional techniques). As mentioned, another exemplary substrate is quartz microfiber. Made from spun quartz fibers, this material is normally used in the analysis of air and water samples because of its purity and non-reactive nature. Quartz can be used in applications that require measurement below 400 nm (below the visible spectrum) because of its transmission of short wavelength light.

### Example 2: Nucleic Acid Measurement

Measurement of nucleic acids requires absorbance measurements at wavelengths of 260 nm and 280 nm. These short wavelengths are unable to pass through most transparent materials, including glass, and as a result devices for measuring nucleic acids rely on windows made from optically clear materials such as quartz. Quartz microfiber discs at the bottom of multiwell plates can be used for inexpensive, single use measurements of DNA/RNA. To prevent interruption of the required short wavelengths, the quartz discs are open on both sides, with capillary action holding the sample in place and reducing evaporation (FIG. 5).

The quartz matrix approach closely matches Nanodrop™ solution phase reads (FIG. 6). A larger read window (>1 mm) and thinner quartz discs can be utilized to improve sensitivity.

1. A multiwell plate comprising a frame portion and a plurality of wells, each well comprising side walls and a bottom, wherein the bottom of at least one well (a) has a layer of porous matrix disposed thereon, or (b) is comprised of a layer of porous matrix, whereby said porous matrix permits a liquid sample of no more than 5 μL to distribute evenly across said porous matrix.

2. The multiwell plate of claim 1, wherein the bottom of at least 50% of the wells (a) has a layer of porous matrix disposed thereon, or (b) is comprised of a layer of porous matrix.

3. The multiwell plate of claim 1, wherein said layer of porous matrix is immobilized in said well.

4. The multiwell plate of claim 1, wherein said layer of porous matrix is immobilized on the bottom of said well.

5. The multiwell plate of claim 1, wherein said frame portion is comprised of plastic, resin, glass, or quartz.

6. (canceled)

7. The multiwell plate of claim 1, wherein the bottom of said well is substantially flat.

8. The multiwell plate of claim 1, wherein the bottom of said well is transparent or translucent.

9. The multiwell plate of claim 1, wherein said porous matrix is transparent or translucent when wet.

10. The multiwell plate of claim 1, wherein said porous matrix comprises a hydrophilic material.

11. (canceled)

12. The multiwell plate claim 1, wherein said porous matrix is a mesh, a foam, a fibrous structure, a gel, a bed of beads, a sponge, a patterned surface, a 3-dimensional scaffold, or a membrane.

13.-16. (canceled)

17. A method of performing a photometric or spectrophotometric measurement on a liquid sample having a small volume, said method comprising:
(i) placing said liquid sample on a layer of porous matrix disposed on a bottom of a well in a multiwell plate, whereby said porous matrix permits said liquid sample to distribute evenly across said porous matrix;
(ii) projecting a light beam onto said liquid sample distributed in said porous matrix; and
(iii) measuring an output optical signal as a function of an interaction between said light beam and said liquid sample.

18. The method of claim 17, wherein said liquid sample has a volume of no more than 20 μL.

19.-21. (canceled)

22. The method of claim 17, wherein said porous matrix is transparent or translucent when wet.

23. The method of claim 17, wherein said porous matrix comprises a hydrophilic material.

24. (canceled)

25. The method of claim 17, wherein said porous matrix is a mesh, a foam, a fibrous structure, a gel, a bed of beads, a sponge, a patterned surface, a 3-dimensional scaffold, or a membrane.

26. The method of claim 17, further comprising, before step (i), a step of pre-treating said porous matrix with a blocking agent.

27. (canceled)

28. The method of claim 17, wherein said photometric or spectrophotometric measurement is performed by a plate reader.

29. The method of claim 17, wherein said output optical signal is absorbance, fluorescence or luminescence.

30.-33. (canceled)

34. The method of claim 17, further comprising placing a transparent cover over said well to prevent or reduce evaporation.

35. The method of claim 17, wherein said photometric or spectrophotometric measurement is continuous over a period of time.
